(19) United States
(12) Patent Application Publication
(10) Pub. No.: US 2006/0069606 A1
(43) Pub. Date: Mar. 30, 2006

(54) Store modeling-based identification of marketing opportunities

(75) Inventors: Mark Kaczkowski, Niles, IL (US); Jayakumar Vijayanathan, Vernon Hills, IL (US); Mary Gutierrez, Schaumburg, IL (US); Jeffrey Stewart, Naperville, IL (US)

Correspondence Address: FITCH EVEN TABIN & FLANNERY, 120 S. LASALLE STREET, SUITE 1600, CHICAGO, IL, 60603-3406, US

(73) Assignee: Kraft Foods Holdings, Inc.

(21) Appl. No.: 10/955,473

(22) Filed: Sep. 30, 2004

(51) Int. Cl. G06F 17/30

(52) U.S. Cl. 705/10

(57) ABSTRACT

Modeled data (12) regarding a plurality of consumer retail outlets is provided (11) and used (15) to identify at least one unleveraged marketing opportunity with respect to increasing sales of at least one consumer commodity via at least one of the plurality of consumer retail outlets. In a preferred approach, these consumer retail outlets correspond to one or more specific limited geographic areas (21) that serve, in general, to further facilitate a granular understanding and application of the provided data.

### TECHNICAL FIELD

This invention relates generally to the identification of marketing opportunities and more particularly to the use of consumer retail outlet data to inform and guide such identification.

### BACKGROUND

Consumer retailing typically comprises a highly competitive endeavor. Modern consumers often have a wide variety of choices competing for their attention. Advertising comprises a long-standing marketing tool to facilitate consumer education and interest to thereby encourage and prompt a specific purchase by such a consumer. Numerous factors tend to greatly diffuse and/or neutralize the value of many prior art advertising approaches.

As one example, today's consumers tend, less and less, to present themselves as a like-thinking, like-experienced, and like-motivated whole. Instead, purchasing needs and interests divide and subdivide upon a great number of lines, such as but not limited to age, gender, culture and/or heritage, financial status, political consciousness and/or conviction, lifestyle, diet and/or medical condition, geographic location, level of attained education, career, race, so-called pop-culture, and technical prowess, to name a few. As a result, consumer product retailers and manufacturers often find themselves facing the need for a plurality of more targeted advertising messages and approaches rather than a monolithic approach as tended to characterize the past.

As another example, today's consumers have a wide (and ever-growing) variety of media consumption opportunities. There are hundreds of specialty interest magazines for example, in addition to a large number of general interest periodicals. Televised news programs range from the more traditional thirty minute or sixty minute daily news program to 24 hour-per-day general and specialized news programming. There are television options that offer no direct advertising opportunities and there are theater venues that now include direct advertising presentations. Radio broadcasting has grown to include a vast number of local stations while also including nationally or regionally syndicated programs and now, more recently, pay-for-service satellite broadcasts that offer at least some non-commercial advertising programming. There are also numerous consumers who eschew more traditional media sources such as television, radio, or printed media in favor of Internet options (including but not limited to both pushed and pulled news and entertainment services and options).

Advertisers, on the other hand, have limited resources. It is often not practical to saturate a given consumer base with a particular message because the costs of achieving that saturation are disproportionate to the likely achieved benefit. For the reasons noted above and many others, the final impact of such an approach will often be so diluted as to render the substantial expected advertising costs a significant bar to participation.

Advertisers are therefore turning, more and more, to increasingly targeted messages and delivery selections. A typical advertiser will now more carefully consider the characterizing demographics of their desired audience and a cost-effective delivery mechanism. Such an approach can, in fact, yield considerable benefit to both the advertiser and the consumer. Some consumers unlikely to be interested are spared the interaction and the advertiser is spared the cost of delivering an unwanted message. Meanwhile, consumers more likely to be interested in the advertising content are provided with that access and opportunity.

While the benefits are clear, implementation remains another matter. Missed opportunities abound for a variety of reasons. One significant reason relates to an absence of useful data. Without data to specifically characterize the nature and scope of a given marketing exercise, theoretical benefit goes largely unmet. Marketing process still remain, for better or for worse, a hit or miss exercise.

Through so-called preferred buyer programs and the like, some retail establishments are able to collect in-depth detail regarding sales at their individual stores. Such information, however, typically remains unavailable (or available only at considerable cost) to outsiders including enterprises that manufacture the items sold. Consequently, insufficient and/or unreliable data remains the rule rather than the exception.

### BRIEF DESCRIPTION OF THE DRAWINGS

The above needs are at least partially met through provision of the store modeling-based identification of marketing opportunities invention described in the following detailed description, particularly when studied in conjunction with the drawings, wherein:

FIG. 1 comprises a flow diagram as configured in accordance with various embodiments of the invention;

FIG. 2 comprises a schematic representation as configured in accordance with various embodiments of the invention;

FIG. 3 comprises a schematic representation as configured in accordance with various embodiments of the invention;

FIG. 4 comprises a schematic representation as configured in accordance with various embodiments of the invention;

FIG. 5 comprises a schematic representation as configured in accordance with various embodiments of the invention;

FIG. 6 comprises a schematic representation as configured in accordance with various embodiments of the invention;

FIG. 7 comprises a schematic representation as configured in accordance with various embodiments of the invention; and

FIG. 8 comprises a schematic representation as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides data regarding a plurality of consumer retail outlets, wherein the data is comprised, at least in part, of modeled data. One then uses this data to identify at least one unleveraged marketing opportunity with respect to increasing sales of at least one consumer commodity via at least one of the plurality of consumer retail outlets.

In many cases, one or more of these consumer retail outlets correspond to one or more specific limited geographic areas. Such limited geographic areas can be fully or partially defined as a function of political boundaries, postal codes, and/or effective or otherwise recognized marketing areas, to name a few.

In a preferred approach, the consumer retail outlets data is used in conjunction with additional data regarding a plurality of consumers when identifying the unleveraged marketing opportunity. Also in a preferred approach, such consumer data preferably corresponds to at least some consumers as are located within one of the specific limited geographic areas.

The unleveraged marketing opportunity can vary widely with circumstance and context. As one example, the unleveraged marketing opportunity can comprise integration of at least one targeted consumer communication with an offering of the at least one consumer commodity. The targeted consumer communication can comprise, for example, a mailing or other communication that is delivered to the homes of targeted consumers, an in-store display, local event marketing, and so forth.

So configured, these teachings permit relatively precise marketing plans to be formulated, on a small, medium, or large geographic scale, with successful results being expected notwithstanding an absence of hard factual data regarding, in particular, sales at individual retail stores. By using such data as may exist and as may be attainable with reasonable effort and cost, and through appropriate extrapolation, interpolation, and analysis of that data, a surprisingly accurate and useful model of various retail stores can be realized. Such retail store models, in turn, facilitate the kind of informed opportunity analysis suggested above.

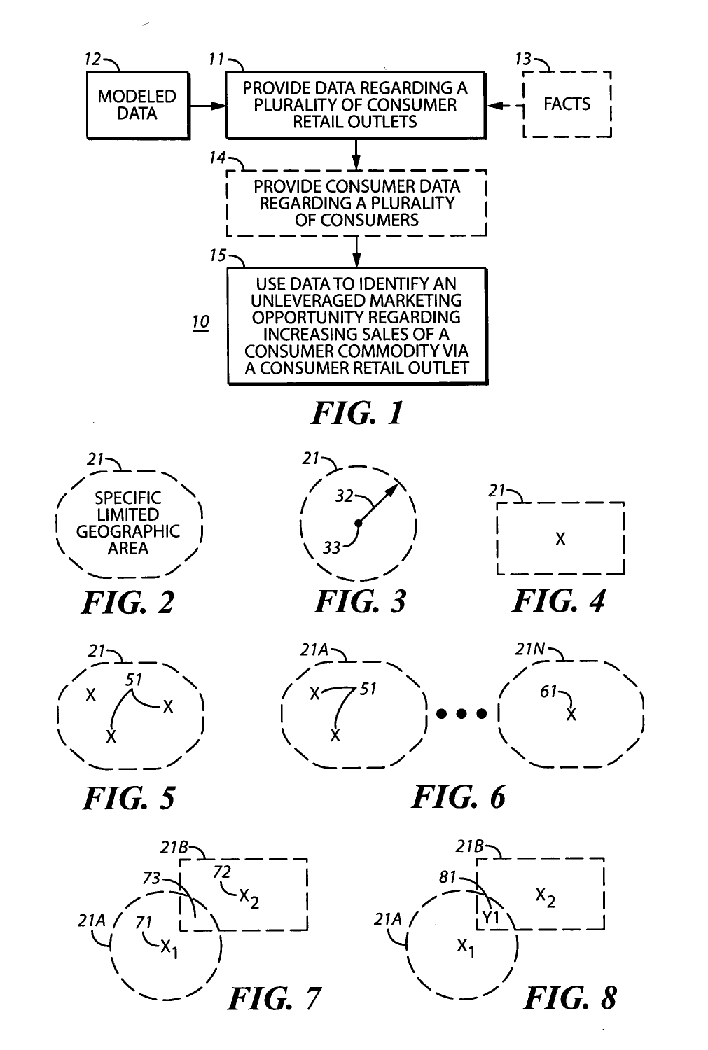

These and other benefits may become clearer upon making a thorough review and study of the following detailed description. Referring now to the drawings, and in particular to FIG. 1, this process 10 typically begins with provision 11 of data regarding a plurality of consumer retail outlets, wherein the data is comprised, at least in part, of modeled data 12. As used herein, modeled retail outlet data shall be understood to comprise data that comprises interpolated and/or extrapolated data (and will frequently comprise data that has been interpolated or extrapolated across categories) as derived from a factual and/or modeled data starting point. Actual facts can be selected and obtained when and as available.

As one example, data for certain individual stores can be obtained through syndicated data providers. Such data may inform the observer, for example, that cheese products typically sell in an amount that is roughly ½ the aggregate sales of certain cracker products. Other data may reveal that cracker sales tend to correlate in a particular manner to sales of wine within a specific price range, presuming certain marketing area characteristics are present regarding, for example, home ownership, typical household makeup, vehicle ownership, and the like. By using census facts regarding such marketing area characteristics, and with access to facts or modeled data regarding wine sales for a given retail outlet, one may then be able to calculate a likely number of cracker products as are sold at that store and hence the likely quantity of cheese products that are sold at that venue.

As another example, grocery purchase information on a household-level basis can be obtained (for example, through syndicated data providers). This household-level data is then readily projected using a model of choice to estimate grocery purchases for each Zip+4 locale within a geographic area of interest. One can also then purchase store-level data that provides basic details regarding various consumer retail facilities in that geographic area of interest (details such as specification location, size of the establishment, availability of special department such as a delicatessen, a bakery, and so forth, availability of banking services, hours of operation, and so forth). The estimated grocery purchases of all Zip+4 areas within this geographic area of interest are then allocated amongst these various retail outlets (typically keeping in mind that many of the households in many of the Zip+4 areas will usually have the opportunity to shop at multiple retail outlets). By then summing together the allocated purchases from each Zip+4 area, one essentially estimates, via modeling, store-level sales for each of the retail outlets in the geographic area of interest.

The accuracy, breadth, and depth of such modeled information can and will vary with the quantity, accuracy, and breadth of data available to the analyst. In many cases it may be possible to cross-correlate modeled data in a plurality of different ways to better substantiate or range the calculated model values. Various modeling techniques are presently known and understood and additional techniques will no doubt be developed in the future. Therefore additional details regarding the development of such modeled data will not be provided here for the sake of brevity and the preservation of focus with respect to these teachings.

Notwithstanding that modeled data 12 will typically be based upon at least some actual facts, it may also be desirable to also provide at least some actual store data 13. As one simple example, an analyst might introduce factual information regarding actual inventory numbers for certain products that a given manufacturer plans to have on hand at specific retail outlets during a specific range of time. Such information could aid, for example, in discouraging a promotion tied to products that are in short supply and in encouraging a promotion that will encourage consumption of one or more products in ready and available quantities likely sufficient to meet hoped-for demand.

When providing such data, including the modeled data, for a plurality of consumer retail outlets, the plurality of consumer retail outlets will typically correspond to one or more specific limited geographic areas that comprise an area of perceived opportunity, concern, interest, or risk. These teachings are compatible and applicable for use with geographic areas of a wide variety of types and sizes.

For example, and referring momentarily to FIG. 2, the specific limited geographic area 21 can comprise a politically defined area (such as but not limited to a sovereign nation, a state or province, a political territory or district, a county, or a municipality (such as a city, town, village, or the like) to name a few. As another example, the specific limited geographic area 21 can comprise an area that is defined by a Zipcode postal code (or other postal code) including, preferentially, a so-called Zip+4 postal code as is used by the United States Postal Service to specify relatively small areas (such as five to ten households in a residential neighborhood). As yet another example, the specific limited geographic area 21 can comprise a designated market area as corresponds to a given consumer retail outlet (i.e., that geographic area that is determined to represent the primary trading area for a given consumer retail outlet).

In some cases, and referring momentarily to FIG. 3, the designated market area 21 as corresponds to a given outlet may be generally and more abstractly represented, such as through use of a circular boundary that is defined, at least in part, by a terrestrial center point 33 (to locate, for example, the consumer retail outlet itself) and a corresponding radius 32 that represents the trade area for that outlet. In other cases, and referring momentarily to FIG. 4, the designated market area 21 as corresponds to a given retail outlet X can have a boundary that varies along whatever lines of demarcation apply in a given instance. For example, certain streets may serve as natural and clear boundaries that well define the expected marketing reach of a given consumer retail outlet.

It should be understood that the plurality of consumer retail outlets 51 as are captured by the data of the foregoing step may all be found within a single specific limited geographic area 21 as is suggested by the illustration of FIG. 5 (as may occur, for example, when the geographic area comprises a given city) and/or may be found in multiple specific limited geographic areas 21A and 21N as is represented by the illustration presented at FIG. 6. When multiple geographic areas are considered, it should also be understood that the geographic areas can vary with respect to type and still be usefully applied within the context of these teachings. For example, and with continued reference to FIG. 6, a first specific limited geographic area 21A may comprise a given suburb having multiple consumer retail outlets 51 within it and a second specific limited geographic area 21N may comprise the designated market area as corresponds to a single consumer retail outlet 61.

Referring momentarily to FIG. 7, those skilled in the art will further appreciate that multiple specific limited geographic areas 21A and 21B, when present, may overlap in part or in whole. As one simple example, a first specific limited geographic area 21A may correspond to the designated market area as corresponds to a first consumer retail outlet 71 and a second specific limited geographic area 21B may correspond to the designated market area as corresponds to a second consumer retail outlet 72 that competes with the first consumer retail outlet 71 for consumers at least within an area of trading area overlap.

Referring again to FIG. 1, in a preferred approach it may also be useful to further provide 14 consumer data regarding a plurality of consumers. In some cases this may comprise specific facts as may be available to the analyst. In other cases, this consumer data may also be comprised, at least in part, of modeled consumer data. It will usually be preferred that the consumer data relate to consumers who are located within at least one of the specific limited geographic areas (such as, but not limited to, within the designated market area for a given consumer retail outlet of interest). With momentary reference to FIG. 8, it will be understood that at least some of these consumers 81 may be located within a predetermined area or distance of at least two of the plurality of consumer retail outlets. In any event it will usually be preferred for most purposes to provide such consumer data on at least a household-by-household basis.

Referring again to FIG. 1, such data regarding consumer retail outlets (and preferably regarding consumers themselves) is used 15 to identify at least one unleveraged marketing opportunity with respect to increasing sales of at least one consumer commodity via at least one of the plurality of consumer retail outlets. Such identification, of course, does not typically occur without thought, reflection, or analysis. The use of such data, however, provides a powerful perspective by which to uncover significant approaches that might otherwise remain unidentified.

In many cases, viewed generally, the unleveraged marketing opportunity so identified will comprise integration of at least one targeted consumer communication with an offering of the aforementioned consumer commodity. Such a targeted consumer communication can assume various forms including mailings (such as pamphlets, recipe cards, magazines, discount coupons, rebate offers, flyers, and so forth) and/or other communications (such as door hangers, newspaper supplements, calendars, welcome kits, kitchen utensils, and so forth) that are delivered to the homes of targeted consumers.

Pursuant to these teachings, integration of a targeted consumer communication with an offering of a consumer commodity can include but is not limited to in-store displays, local event marketing, and the like. Such an in-store display may comprise an in-store display that corresponds to the content of the targeted consumer communication. For instance, the modeled store data can be used to identify an unleveraged marketing opportunity with respect to likely increasing sales by identifying a plurality of consumer commodities that can be marketed in common with one another in conjunction with a corresponding out-of-store consumer marketing approach (such as a media-based point of consumer contact such as but not limited to a direct mail offering, an electronic mail offering, a televised offering, a radio broadcast offering, and so forth) and an in-store consumer marketing approach.

As one such example, the in-store display can comprise an aggregated display of a plurality of different consumer commodities that relate to one another via such a targeted consumer communication. To illustrate, the targeted consumer communication may comprise a recipe in a direct mailing calculated to be of likely interest to the inhabitants of a given household within a specific limited geographic area, and a corresponding in-store display can comprise an aggregation of the ingredients for that recipe to more readily facilitate pursuit of the recipe by the recipient consumer.

As mentioned above, such integration can also comprise use of local event marketing that, again, correlates and/or corresponds to the content of the above-mentioned targeted consumer communication. Such local event marketing can comprise, but is not limited to, public event booths such as booths offered at a fair, a festival, a conference, an exhibition, a convention, or the like, wherein the content of the booth or the message delivered thereby comprises an integration aspect of the overall marketing opportunity.

Other possibilities exist. For example, the above-described data can be used to identify an unleveraged marketing opportunity such as optimally determining where to allocate a scarce marketing resource such as an entertainment event, a particular relatively scarce in-store display, or a limited supply of consumer commodity containers (such as, but not limited to, a refrigerated commodity container particularly sized and configured to optimally store and/or display a given commodity).

To illustrate, a given manufacturer may have 200 refrigerator units particularly appropriate for storing and displaying a particular product line, which units need to be distributed over 500 candidate consumer retail outlets within a given specific limited geographic area of interest (such as a give state). In the past, this manufacturer might simply have opted for a simple solution such as placing these 200 units at the top-yielding 200 outlets (i.e., those outlets that presently exhibit a highest level of sales of the manufacturer's products). Such an allocation, however, may very well be sub-optimal. Pursuant to these teachings, the manufacturer can consider the issue from a better-informed perspective. For example, modeled store information may indicate those stores where the manufacturer's sales are still acceptable, but where a competitor's products are making evident inroads (which inroads may not even yet be observable as lost market share to the manufacturer). This perspective, in turn, can prompt the manufacturer to locate at least some of these scarce display resources at stores that might offer a greater opportunity, on balance, than more traditional high-performing stores.

As another illustration, product allocation within a given retail establishment may be better leveraged via these teachings. For example, a given retail establishment may allocate five feet of shelf space to adult cereals and five feet of shelf space to children's cereals. Modeled store-level data, however, may reveal that cereals in general are not selling as well as should be expected. Analysis of the underlying modeled data, such as Zip+4-level data as is described above, may reveal an imbalance in a particular region between the number of likely adult and children consumers. In an area having fewer children than normal, the above-described allocation of shelf space may represent an inappropriate imbalance. By increasing shelf space dedicated to adult cereals, and reducing shelf space accorded to children's cereals, overall cereal sales may well increase without any overall increase in shelf space requirements and without unduly hurting sales of children's cereals.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, modeled store-level data could be used to identify the best areas and/or retail establishments to use when launching or testing a new product or when distributing samples of an existing product.

We claim:

1. A method comprising:
providing data regarding a plurality of consumer retail outlets, wherein the data is comprised, at least in part, of modeled data;
using the data to identify at least one unleveraged marketing opportunity with respect to increasing sales of at least one consumer commodity via at least one of the plurality of consumer retail outlets.

2. The method of claim 1 wherein the plurality of consumer retail outlets correspond to a specific limited geographic area.

3. The method of claim 2 wherein the specific limited geographic area comprises at least one of:
a sovereign nation;
a state;
a province;
a political territory;
a county;
municipality;
a political district.

4. The method of claim 2 wherein the specific limited geographic area comprises an area defined, at least in part, by a terrestrial center point and a corresponding radius.

5. The method of claim 1 wherein the plurality of consumer retail outlets correspond to a plurality of at least partially discrete geographic areas.

6. The method of claim 1 wherein the plurality of consumer retail outlets comprise consumer retail outlets that are located within a specific limited geographic area as is defined by a Zipcode postal code.

7. The method of claim 6 wherein the Zipcode postal code comprises a Zip+4 postal code.

8. The method of claim 1 wherein the plurality of consumer retail outlets comprise consumer retail outlets that are located within a plurality of specific limited geographic areas, wherein at least one of the specific limited geographic areas is defined by a Zipcode postal code.

9. The method of claim 8 wherein the Zipcode postal code comprises a Zip+4 postal code.

10. The method of claim 1 and further comprising:
providing consumer data regarding a plurality of consumers, wherein the consumer data is comprised, at least in part, of modeled consumer data;
and wherein using the data to identify at least one unleveraged marketing opportunity further comprises using the data and using the consumer data to identify the at least one unleveraged marketing opportunity.

11. The method of claim 10 wherein providing consumer data regarding a plurality of consumers further comprises providing consumer data regarding consumers as are located within a predetermined area of at least one of the plurality of consumer retail outlets.

12. The method of claim 11 wherein providing consumer data regarding consumers as are located within a predetermined area of at least one of the plurality of consumer retail outlets further comprises providing consumer data regarding at least one consumer that is located within a predetermined area of each of at least two of the plurality of consumer retail outlets.

13. The method of claim 10 wherein providing consumer data regarding a plurality of consumers further comprises providing consumer data on a household-by-household basis.

14. The method of claim 1 wherein the data to identify at least one unleveraged marketing opportunity further comprises identifying at least one unleveraged marketing opportunity that comprises integrating at least one targeted consumer communication with an offering of the least one consumer commodity.

15. The method of claim 14 wherein the at least one targeted consumer communication comprises a mailing.

16. The method of claim 15 wherein the mailing comprises at least one of:
a pamphlet;
a recipe;
a magazine;
a discount coupon;
a rebate offer.

17. The method of claim 14 wherein the at least one targeted consumer communication comprises a communication that is delivered to homes of targeted consumers.

18. The method of claim 17 wherein the communication comprises at least one of:
a mailing;
a door hanger;
a supplement to a newspaper;
a calendar;
a welcome kit;
a kitchen utensil.

19. The method of claim 14 wherein integrating at least one targeted consumer communication with an offering of the least one consumer commodity further comprises providing an in-store display that corresponds to content of the at least one targeted consumer communication.

20. The method of claim 19 wherein providing an in-store display that corresponds to content of the at least one targeted consumer communication further comprises providing an in-store display comprised of a plurality of different consumer commodities that relate to one another via the at least one targeted consumer communication.

21. The method of claim 14 wherein integrating at least one targeted consumer communication with an offering of the at least one consumer commodity further comprises providing local event marketing that corresponds to content of the at least one targeted consumer communication.

22. The method of claim 21 wherein the local event marketing comprises a public event booth.

23. The method of claim 22 wherein the public event booth comprises a booth that is offered at one of:
a fair;
a festival;
a conference;
an exhibition;
a convention.

24. The method of claim 1 wherein using the data to identify at least one unleveraged marketing opportunity further comprises using the data to determine where to allocate a scarce marketing resource.

25. The method of claim 24 wherein the scarce marketing resource comprises an in-store display.

26. The method of claim 24 wherein the scarce marketing resource comprises an in-store consumer commodity container.

27. The method of claim 24 wherein the scarce marketing resource comprises an entertainment event.

28. A method to facilitate identification of an unleveraged marketing opportunity, comprising:
providing modeled store data regarding a plurality of retail stores;
using the modeled store data to identify at least one unleveraged marketing opportunity with respect to likely increasing sales of at least one consumer commodity.

29. The method of claim 28 wherein providing modeled store data further comprises providing at least some actual store data and wherein using the modeled store data further comprises using both the modeled store data and the at least some actual store data.

30. The method of claim 29 wherein the plurality of retail stores are located within a designated market area.

31. The method of claim 30 wherein the plurality of retail stores are located within a designated market area comprising at least one of:
a political entity comprising at least one of:
a sovereign nation;
a state;
a province;
a political territory;
a county;
municipality;
a political district;
a non-politically-defined geographic area defined as a primary trading area for at least one of the retail stores.

32. The method of claim 31 wherein using the modeled store data to identify at least one unleveraged marketing opportunity with respect to likely increasing sales of at least one consumer commodity further comprising using the modeled store data to identify a plurality of consumer commodities that can be marketed in common with one another in conjunction with a corresponding out-of-store consumer marketing approach and an in-store consumer marketing approach.

33. The method of claim 32 wherein the out-of-store consumer marketing approach further comprises a media-based point of consumer contact.

34. The method of claim 33 wherein the media-based point of consumer contact further comprises at least one of:
a direct mail offering;
an electronic mail offering;
a televised offering;
a radio broadcast offering.

35. The method of claim 34 wherein the media-based point of consumer contact further comprises, at least in part, a food recipe.
